(19) United States
(12) Patent Application Publication
(10) Pub. No.: US 2026/0141672 A1
(43) Pub. Date: May 21, 2026

(54) METHOD, APPARATUS, DEVICE, MEDIUM AND PROGRAM PRODUCT FOR PROCESSING DATA

(71) Applicant: Beijing Zitiao Network Technology Co., Ltd., Beijing (CN)

(72) Inventors: Shaoqi LU, Beijing (CN); Chenghao Liu, Beijing (CN); Zhiguang Chen, Beijing (CN); Fenghai Yang, Beijing (CN)

(21) Appl. No.: 19/390,166

(22) Filed: Nov. 14, 2025

(30) Foreign Application Priority Data
Nov. 15, 2024 (CN) 202411640215.X

(51) Int. Cl. G06V 10/28; G06N 3/0455; G06N 3/0475; G06T 3/40; G06V 10/32

(52) U.S. Cl. CPC G06V 10/28; G06N 3/0455; G06N 3/0475; G06T 3/40; G06V 10/32

(57) ABSTRACT

Embodiments of the present disclosure relate to a method, an apparatus, a device, a medium, and a program product for processing data. The method comprises acquiring first media content at a client, the first media content corresponding to a first modality in a plurality of modalities for a multi-modal model. The method further comprises generating a first content feature for the first media content based on a first part of the multi-modal model deployed at the client. The method further comprises sending the first content feature to a server to process the first content feature and a second content feature of second media content corresponding to a second modality in the plurality of modalities by using a second part of the multi-modal model deployed on the server, a computational load of the second part being greater than that of the first part.

### CROSS-REFERENCE TO RELATED APPLICATION(S)

This application claims priority to Chinese Application No. 202411640215.X filed Nov. 15, 2024, the disclosure of which is incorporated herein by reference in its entirety.

### FIELD

Embodiments of the present disclosure generally relate to the field of machine learning models, and specifically to a method, an apparatus, a device, a medium and a program product for processing data.

### BACKGROUND

Currently, the machine learning industry is developing at an increasingly rapid pace. A growing variety of machine learning models have emerged and are being widely applied to different industries and domains. For instance, a vision-related model may be applied to a field such as visual inspection and autonomous driving, and a language-related model may be applied to fields such as text processing and knowledge-based question answering. Additionally, multi-modal machine learning models, which integrate various specialized models with different focuses, may be deployed in more complex tasks that span multiple different fields.

### SUMMARY

Embodiments of the present disclosure provide a method, an apparatus, a device, a medium and a program product for processing data.

According to a first aspect of the present disclosure, there is provided a method for processing data. The method comprises acquiring first media content at a client, the first media content corresponding to a first modality in a plurality of modalities for a multi-modal model. The method further comprises generating a first content feature for the first media content based on a first part of the multi-modal model deployed at the client. The method further comprises sending the first content feature to a server to process the first content feature and a second content feature of second media content corresponding to a second modality in the plurality of modalities by using a second part of the multi-modal model deployed on the server, a computational load of the second part being greater than that of the first part, and a number of parameters of the second part being greater than that of the first part. The method further comprises receiving from the server a processing result for the first media content and the second media content output by the multi-modal model.

According to a second aspect of the present disclosure, there is provided a method for processing data. The method comprises receiving, at a server, a first content feature for first media content from a client, the first media content corresponding to a first modality in a plurality of modalities for a multi-modal model, and the first content feature being generated by a first part of the multi-modal model processing the first media content. The method further comprises determining a second content feature of second media content corresponding to a second modality in the plurality of modalities. The method further comprises generating a processing result for the first media content and the second media content by applying the first content feature and the second content feature to a second part of the multi-modal model, a computational load of the second part being greater than that of the first part, and a number of parameters of the second part being greater than that of the first part. The method further comprises sending the processing result for the first media content and the second media content to the client.

In a third aspect of the present disclosure, there is provided an apparatus for processing data. The apparatus comprises a first media content acquisition module configured to acquire first media content at a client, the first media content corresponding to a first modality in a plurality of modalities for a multi-modal model; a first content feature generation module configured to generate a first content feature for the first media content based on a first part of the multi-modal model deployed at the client; a first content feature and second content feature processing module configured to send the first content feature to the server to process the first content feature and a second content feature of second media content corresponding to a second modality in the plurality of modalities by using a second part of the multi-modal model deployed on the server, a computational load of the second part being greater than that of the first part, and a number of parameters of the second part being greater than that of the first part; and a processing result receiving module configured to receive from the server a processing result for the first media content and the second media content output by the multi-modal model.

In a fourth aspect of the present disclosure, there is provided an apparatus for processing data. The apparatus comprises a first content feature receiving module configured to receive, at a server, a first content feature for first media content from a client, the first media content corresponding to a first modality in a plurality of modalities for a multi-modal model, and the first content feature being generated by a first part of the multi-modal model processing the first media content; a second content feature determination module configured to determine a second content feature of second media content corresponding to a second modality in the plurality of modalities; a processing result generation module configured to generate a processing result for the first media content and the second media content by applying the first content feature and the second content feature to a second part of the multi-modal model, a computational load of the second part being greater than that of the first part, and a number of parameters of the second part being greater than that of the first part; and a processing result sending module configured to send the processing result for the first media content and the second media content to the client.

In a fifth aspect of the present disclosure, there is provided an electronic device, comprising at least one processor; and a storage device for storing at least one program which, when executed by the at least one processor, causes the at least one processor to implement the methods in the first aspect and second aspect of the present disclosure.

In a sixth aspect of the present disclosure, there is provided a computer readable storage medium having stored thereon a computer program which, when executed by a processor, implements the methods in the first aspect and second aspect of the present disclosure.

In a seventh aspect of the present disclosure, there is provided a computer program product. The computer program product comprises a computer program which, when executed by a processor, implements the methods in the first aspect and second aspect of the present disclosure.

It should be appreciated that the content described in Summary part is not intended to define essential or important features of embodiments of the present disclosure or to limit the scope of the present disclosure. Other features of the present disclosure will be made apparent by the following description.

### BRIEF DESCRIPTION OF THE DRAWINGS

The above and other objects, features and advantages of the present disclosure will become more apparent by reference to the following more detailed description of example embodiments of the present disclosure in conjunction with the accompanying drawings, wherein the same reference numerals usually denote the same parts in the example embodiments of the present disclosure.

FIG. 1 illustrates a schematic diagram of an example environment in which an apparatus and/or a method according to some embodiments of the present disclosure may be implemented;

FIG. 2 illustrates an example of deploying a multi-modal model according to some embodiments of the present disclosure;

FIG. 3 illustrates a schematic diagram of an example method for processing data according to some embodiments of the present disclosure;

FIG. 4 illustrates a schematic diagram of an example method for processing data according to some embodiments of the present disclosure;

FIG. 5 illustrates a schematic diagram of an example in which a multi-modal model is a stable diffusion model according to some embodiments of the present disclosure;

FIG. 6 illustrates a schematic diagram of an example in which the multi-modal model is a bootstrapped-image pre-training model according to some embodiments of the present disclosure;

FIG. 7 illustrates a schematic block diagram of an apparatus for processing data according to some embodiments of the present disclosure;

FIG. 8 illustrates a schematic block diagram of an apparatus for processing data according to some embodiments of the present disclosure;

FIG. 9 illustrates a schematic block diagram of an example device adapted to implement multiple embodiments of the present disclosure.

In all the figures, the same or like reference numerals denote the same or like parts.

### DETAILED DESCRIPTION OF EMBODIMENTS

With the accelerated development of the machine learning industry, new technologies related to machine learning continue to emerge, and there are more and more application scenarios for machine learning models. As the application scenarios grow more complex, the barriers for using machine learning models are also rising. For example, complex scenarios may require the use of many different types of machine learning models or the use of the same machine learning model at different stages. In such cases, there are higher requirements for the use of the machine learning model because the operational demands need to be met and resources should be saved as much as possible. Therefore, there are many aspects to be studied on how to apply the machine learning models more efficiently.

It may be appreciated that data (including but not limited to the data itself, acquisition or use of data) involved in the technical solution should comply with requirements in relevant laws and regulations and relevant provisions.

It is to be understood that, before the technical solutions disclosed in the embodiments of the present disclosure are used, a user should be informed of a type, a use range, a use scenario, etc. of personal information involved in the present disclosure and authorization should be obtained from the user in an appropriate manner according to relevant laws and regulations.

For example, when the user's active request is received, prompt information is sent to the user to explicitly prompt the user that the operation requested to be performed will require the acquisition and use of the user's personal information. Accordingly, the user may autonomously decide according to the prompt information whether to provide his personal information to software or hardware, such as an electronic device, an application, a server or a storage medium, which performs the operation of the technical solution of the present disclosure.

As an optional but non-limiting implementation, a manner of sending the prompt information to the user in response to receiving the user's active request may for example be a pop-up window in which the prompt information may be presented in a text. In addition, the pop-up window may also carry a selection control for the user to select “agree” or “disagree” to provide or not provide the personal information to the electronic device.

It may be appreciated that the above process of notifying and obtaining the user's authorization is merely illustrative and not intended to limit implementations of the present disclosure, and that other manners satisfying relevant laws and regulations may also be applied to implementations of the present disclosure.

Hereinafter, embodiments of the present disclosure will be described in more detail with reference to the figures. Although some embodiments of the present disclosure are shown in the figures, it is to be understood that the present disclosure may be implemented in various forms and should not be construed as being limited to the embodiments illustrated herein; rather, these embodiments are provided to enable more thorough and complete understanding of the present disclosure. It should be appreciated that the drawings and embodiments of the present disclosure are for illustrative purposes only and are not intended to limit the scope of the present disclosure.

In the description of the embodiments of the present disclosure, the term “include” or like words should be considered as being open-ended, i.e., “include but not limited to”. The term “based on” should be understood as meaning “based at least in part on”. The terms “one embodiment” or “the embodiment” should be understood as “at least one embodiment”. The terms “first”, “second” and the like may refer to different or identical objects unless expressly stated otherwise. Other explicit and implicit definitions may also be included below.

With the development of pre-training and self-supervised learning techniques, as well as the introduction of a natural language modality into a vision task, many tasks have achieved groundbreaking progress. Large multi-modal models based on vision and language have become a key focus in both academic research and product development, leading to the emergence of many generative-type models and comprehension-type models. In the current phase, application computation of many machine learning models, such as large models, occurs at a server side, while a client merely serves as an interface for capability delivery and a service request initiator, sending data to the server side. A large number of requests will cause an excessive pressure load on the server side, and the bandwidths required for data upload and download also cause new issues.

In the above-mentioned traditional approaches, a pure cloud service depends on network conditions and server resources and is costly, whereas a pure client-side deployment imposes excessively high requirements for the client-side hardware and also causes a problem about difficult deployment. Therefore, the above two separate deployment approaches cannot effectively solve the problem that the machine learning model cannot be sufficiently used on the server side and the client. Furthermore, due to a problem such as network instability, when a task related to a machine learning model is performed, the computational efficiency will be significantly reduced, a substantial computational burden will be caused to the server, and a challenge will be caused to the computation cost of the server. On the other hand, if the computational task is totally placed at the client for execution, high requirements will be imposed on the performance of the hardware of the client side such as Graphics Processing Unit (GPU). Given the current client lacks a computing power, the hardware cost at the client also increases substantially. According to both the traditional approaches, extremely high requirements are imposed on the performance and maintenance cost of the hardware, the computational task is caused instable and prone to influences due to the network instability, and the user's experience upon performing the computational task using the machine learning model is reduced to a very large degree.

To address at least the above and other potential problems, embodiments of the present disclosure provide a method for processing data. In the method, first media content may first be acquired at the client. The first media content corresponds to a first modality in a plurality of modalities of a multi-modal model. Next, a first content feature for the first media content may be further generated using a first part of the multi-modal model deployed at the client. The first content feature is then sent by the client to a server to process the first content feature and a second content feature of second media content corresponding to a second modality in the plurality of modalities by using a second part of the multi-modal model deployed on the server. The computational load of the second part is greater than that of the first part, and a number of parameters of the second part is greater than that of the first part, so that a large amount of computation related to the model is performed at the server side, and the processing of content of different modalities related to the user may be implemented at the client. Then, the client may receive from the server a processing result for the first media content and the second media content output by the multi-modal model. By this method, the multi-modal model is deployed in the client and server in a hybrid manner, which reduces the latency, reduces the demands of the service for the bandwidth, reduces the computational cost of the server, and improves the processing efficiency and user's experience.

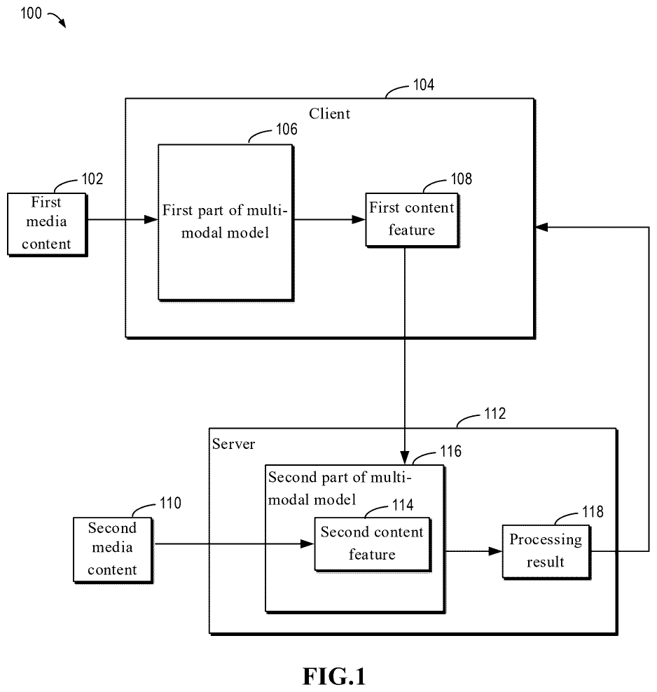

Embodiments of the present disclosure will be described in further detail below with reference to the figures. FIG. 1 illustrates an example environment in which an apparatus and/or a method according to an embodiment of the present disclosure may be implemented. In environment 100, a client 104 may be used to handle a computational task having a small computational load and consuming less computational resources in a multi-modal model, e.g., encode input media content with an encoder, perform a fewer-dimensional transformation, etc. A server 116 may be used to handle a computational task having a large computational load and consuming massive computational resources in the multi-modal model, e.g., a joint processing operation of a large number of text features and image features. The multi-modal model may process data of different modalities, for example, the multi-modal model may be a multi-modal model that processes data of an image modality, a video modality, a text modality, and/or an audio modality, and a plurality of modalities may comprise at least two different modalities. First media content 102 and second media content 114 may be content corresponding to different modalities.

First, the first media content 102, such as an image or video input by a user to be processed, is acquired at the client 104. The first media content 102 corresponds to a first modality in the plurality of modalities that may be processed by a multi-modal model 106. In some embodiments, the plurality of modalities may comprise a visual modality, a language modality, and an auditory modality. In some embodiments, the plurality of modalities may comprise an image modality, a video modality, a text modality, and an audio modality. At this time, the first media content 102 may correspond to one of the above modalities.

For example, when the first media content 102 is an image, the first media content 102 corresponds to an image modality or a visual modality. If the first media content 102 is text content, the first media content 102 corresponds to a language modality or a text modality. When the first media content 102 is audio, the first media content 102 corresponds to an auditory modality or an audio modality.

Then, the first media content 102 is processed using a first part 106 of the multi-modal model deployed at the client 104 to generate a first content feature 108 for the first media content 102. Next, the client 104 will send the first content feature 108 to the server 112 to process the first content feature 108 and a second content feature 114 of second media content 110 corresponding to a second modality in the plurality of modalities by using a second part 116 of the multi-modal model deployed on the server 112. A computational load of the second part of the multi-modal model is greater than that of the first part 106 of the multi-modal model, and a number of parameters of the second part 116 of the multi-modal model is greater than that of the first part 106 of the multi-modal model.

In some embodiments, the second content feature 114 is similar to the first content feature 108 and is also obtained by processing the second media content 110 via the first part 106 of the multi-modal model. In some embodiments, the second content feature 114 is obtained by processing the second media content 110 via the second part 116 of the multi-modal model. The foregoing examples are only used to describe the present disclosure and not specific limitations of the present disclosure.

In some embodiments, the first part 106 of the multi-modal model in the client 104 is used to process content having a small computational load and consuming less computational resources, e.g., obtaining a feature of the first media content 102. The second part 116 of the multi-modal model in the server 116 is used to process content having a large computational load and consuming more computational resources, e.g., processing a combination of the first content feature and the second content feature.

In some embodiments, the computational load and the number of parameters of a computational task processed by the second part 116 of the multi-modal model are by far greater than those of a computational task processed by the first part 106 of the multi-modal model, and the number of parameters of the computational task processed by the second part 116 of the multi-modal model differs from the number of parameters of the computational task processed by first part 106 of the multi-modal model by several orders of magnitude.

Additionally, the first part 106 of the multi-modal model is only used to process user-related data, such as image data provided by the user, whereas the second part 116 of the multi-modal model is used to process feature data converted from the user-provided data. In some embodiments, the client 104 further has a hardware device that may accelerate the computational task, such as a graphics processor, an accelerator, or the like.

After the computational task for the first content feature 108 and the second content feature 114 is performed using the second part 116 of the multi-modal model, a resultant processing result 118 is sent from the server 116 to the client 104. It may be appreciated that the communication between the client 104 and the server 116 is achieved via a network. Processing the first media content and second media content by the multi-modal model described above with reference to FIG. 1 is only an example and is not construed as a specific limitation of the present disclosure. The multi-modal model may process the media content corresponding to any suitable number of modalities.

In some embodiments, to reduce the amount of data transmission, the first content feature 108 may undergo a quantization process. For example, the data in the first content feature 108 is converted from a 32-bit floating point number to an 8-bit integer. Then, after receiving the quantized first content feature 108, the server 112 performs a dequantization process to obtain a recovered first content feature. Additionally, after the quantization process is performed on the first content feature 108, the quantized first content feature may be encoded, e.g., encoded by a Portable Network Graphics (PNG) method to further compress the data. The server 112 may decode the compressed-encoded first content feature to obtain the first content feature and may convert the dimensionality to the same dimensionality as the second content feature 114 for unified processing by the second part 116 of the multi-modal model.

By this method, it is possible to, by putting the content provided by the user at the client for processing, use the computing resources of the client and the server to a maximum degree, reduce the computational load of the server, and reduce the overall bandwidth of the service, and it is also possible to, by accelerating the computational task with the hardware at the device side, greatly improve the execution efficiency of the computational task, reasonably allocate the consumption of the computing resources, and improve the user's experience in performing the computational task.

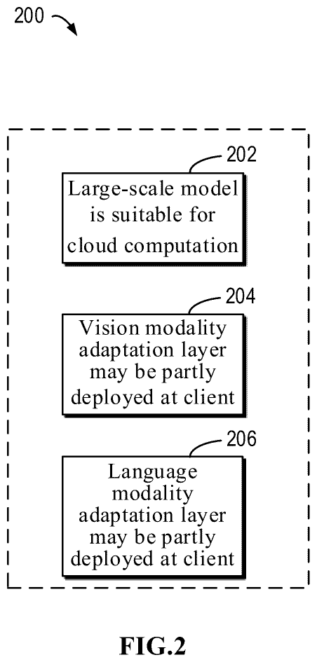

The schematic diagram of the example environment in which an apparatus and/or a method according to some embodiments of the present disclosure may be implemented is descried above with reference to FIG. 1. Reference will be made below to FIG. 2 to describe an example of deploying a multi-modal model according to some embodiments of the present disclosure.

As shown in FIG. 2, in an example 200, an example of deploying a multi-modal model in the process of processing data is presented. At block 202, a large-scale model is suitable for cloud computing and thus deployed on the cloud. A part of the multi-modal model currently deployed on the cloud usually has an extremely high data processing capacity, and may process data with a massive throughput simultaneously. Furthermore, since its computing power imposes extremely high requirements, a very large number of hardware devices are usually needed.

The server on the cloud usually receives data processing requests from different users via a network, and may process different data processing requests of a large number of users simultaneously. Therefore, the server on the cloud needs to have very high upstream and downstream bandwidths to provide support for data transmission. Meanwhile, the server on the cloud needs to have a storage capacity for storing massive data, to save massive data, including data related to the user and other relevant data.

At block 204, a visual modality adaptation layer may be partially deployed at the client, so it is deployed at the client. Since the visual modality matching layer generally directly contacts the data provided by the user, and the amount of the data provided by the user usually has a small order of magnitude, processing may be directly performed at the client side, e.g., by using a graphics processor or other types of hardware accelerators carried on the user equipment. Therefore, placing the visual modality matching layer downstream to the client side for processing at the client may reduce the computation load of the server, and meanwhile reduce a bandwidth increase and a time consumption of data transmission between the client and the server, the effect being particularly significant in a case where the user's data is massive.

At block 206, a language modality adaptation layer may be partly deployed at the client, so that it is deployed at the client. Similar to the visual modality adaptation layer, the language modality adaptation layer also generally contacts the data provided by the user, and the content related to the language modality may also be subjected to data processing at the client. Additionally, an audio modality adaptation layer may also be partially deployed at the client, and the audio data related to the user may be directly processed at the client.

It is possible to, in such a deployment manner that the multi-modal model is partially deployed at the client, put the content provided by the user at the client for processing, use the computing resources of the client and the server to a maximum degree, reduce the computational load of the server, and reduce the overall bandwidth of the service, and it is also possible to, by accelerating the computational task with the hardware at the client side, greatly improve the execution efficiency of the computational task, reasonably allocate the consumption of the computing resources, and improve the user's experience in performing the computational task.

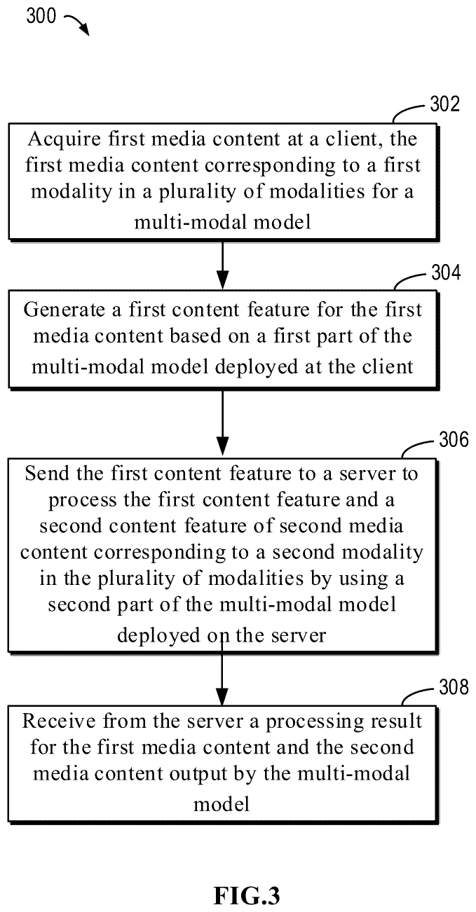

The example of deploying a multi-modal model according to some embodiments of the present disclosure is described above with reference to FIG. 2. Reference is made below to FIG. 3 which illustrates a schematic diagram of an example method 300 for processing data according to some embodiments of the present disclosure. The method shown in FIG. 3 may be performed by the client 104 in FIG. 1 or any suitable computing device.

As shown in FIG. 3, in an example method 300, at block 302, first media content 102 is acquired at the client 104, the first media content 102 corresponding to a first modality in a plurality of modalities for a multi-modal model. Typically, the data processed by the multi-modal model, such as an image or video to be processed by the user, is provided by the user through a client device. Additionally, the user may also input, from the client, information for other modalities of the multi-modal model, such as text information.

In some embodiments, the first media content may only comprise single-modality content, i.e., only comprise image content, video content, text content, or audio content. In some other embodiments, the first media content may comprise multi-modally composited content, and may comprise multiple items or all items of image content, video content, text content, and audio content.

At block 304, a first content feature for the first media content is generated based on a first part of the multi-modal model deployed at the client. To make reasonable use of the client's hardware resources, a portion of functions of the multi-modal model may be configured at the client to process the media content acquired by the client 104. For example, when the first media content 102 comprises image content, a first part of service for processing the image in the multi-modal model may be deployed at the client 104 to process the image content in the first media content.

In some embodiments, when the image in the first media content 102 has a resolution of 1920×1080 and is an image in JPEG format, the first part of the multi-modal model may be used to dimensionally process the image, e.g., reduce the dimensionality of the image. For example, an image with a resolution 320×180 may be obtained from the 1920×1080 resolution after calculation by an encoder, and then a feature vector of the image with the reduced resolution is generated as the first content feature for the first media content.

Additionally, image format encoding may also be performed on the encoded image or quantized image, for example, the image in the JPEG format is PNG-encoded to obtain an image in a PNG format. As compared with the image in the traditional format, the image in the PNG format can be stored repeatedly, is not prone to occurrence of distortion and can achieve a complex image effect.

Additionally, when the first media content comprises an image, the multi-modal model used in the process of generating the first content feature is a stable diffusion model, and the encoder in the first part used for compressed-encoding the image is a variational autoencoder in the stable diffusion model.

In some embodiments, when the first media content comprises video content, the video content portion of the first media content may also be processed using the first part of the multi-modal model. When the video content is processed, since video is typically generated by compressed encoding, a decoding operation is first required on the video to determine the decoded video. Then, a frame extraction operation is performed on the decoded video, e.g., the frame extraction may be performed on the decoded video using a preset frame extraction algorithm, or the frame extraction may be performed on the decoded video using a frame extraction script obtained by a previous manual frame extraction operation. In one example, 10 frames are extracted from the original video having 24 frames, a group of video frames is determined by using the 10 frames of image obtained from the frame extraction, and then pre-processing is performed on the group of video frames. Common pre-processing comprises adjusting the size of the video frames in the group of video frames, performing spatial conversion on the color of images in the group of video frames, and/or performing a normalization process on the video frames.

In some embodiments, the images of the group of video frames may be uniformly scaled down or up. In some embodiments, the adjusting the size of the video frames comprises unifying the size of the images and unifying frame images with different sizes into images with the size. One of the manners is cropping a portion (224×224) from the original image (e.g., with a size of 256×256) using a cropping algorithm, and a real size ratio of the original image is retained. A portion of image may be cropped from a central position of the original image, or a portion of image may be cropped from each of four corner regions of the original image. It is possible to, by the cropping algorithm, crop main information from the image, and ignore other unimportant information. Another manner is padding a designated value to the top/bottom of or around the original image by a padding method, for example, padding black borders of the same size to the top/bottom of or around the image. This method will not change the original data morphology and will not lose the original information of the original image.

The pre-processing further comprises performing spatial conversion on the color of the images in the group of video frames, for example, using a spatial conversion identification code to convert the images between different colors and different spaces, such as between red (R), green (G), blue (B) and BGR or luminance (Y), chrominance (U), and concentration (V). The pre-processing may further comprise realizing the conversion from the color of the images RGB to hue (H), saturation(S), and lightness (V) spaces using single pixel mapping, and achieving the conversion from the color of the images RGB to YUV spaces using a bitwise operation, etc.

In addition, the converted image may be subjected to a normalization process to convert pixel values of the image data of the group of video frames into a specified range. Additionally, when the first media content comprises a video, the multi-modal model used in the process of generating the first content feature is a bootstrapped language-image pre-training model using a frozen image encoder and a large language model, the first part comprising a part of a vision transformer.

At block 306, the first content feature is sent to the server to process the first content feature and a second content feature of second media content corresponding to a second modality in the plurality of modalities using a second part of the multi-modality model deployed on the server, a computational load of the second part being greater than that of the first part, and a number of parameters of the second part being greater than that of the first part.

In some embodiments, after the first content feature is obtained, the client 104 may also perform a quantization process on first content feature 108, e.g., quantize the original first content feature data with a 32-bit floating point precision or a 16-bit floating point precision to an integer precision, to reduce the bandwidth and time consumed needed in the subsequent data transmission.

Then, the quantized first content feature is transmitted to the server for further processing using the second part of the multi-modal model deployed on the server. Additionally, to ensure the consistent precision of the content features, the transmitted first content feature needs to be dequantized to recover the original data precision of the first content feature to ensure the accuracy of a subsequent calculation result.

After the first content feature has been quantized, an encoding operation such as a PNG encoding operation may be performed on the quantized content feature, to determine the quantized first content feature as the encoded first content feature. Then, the client 104 transmits the encoded first content feature to the server 112 for further computational processing using the multi-modal model deployed on the server.

At block 308, a processing result for the first media content and the second media content output by the multi-modal model is received from the server. After having finished the processing of the first content feature 102 and second content feature 114, the server 112 returns a corresponding processing result to the client 104. Additionally, the second part 116 of the multi-modal model may also process other content features.

The client 104 communicates with the server 112 over a network, and a bandwidth increase and time consumption needed in the communication may be determined by a speed at which the client 104 and the server 112 process data and the size of the data contained in the data processing result. Furthermore, it needs to be appreciated that the number of parameters in the data processed by the server is much larger than that in the data that the client needs to process, and therefore the computational load of the server is much larger than that of the client.

Additionally, in order to reasonably allocate parts of the multi-modal model deployed at the client and server, the multi-modal model needs to be divided, i.e., the multi-modal model may be divided into a first candidate part and a second candidate part. Then, the processing of the data of the first media content may be performed using the first candidate part and the second candidate part. Then, calculation of a latency degradation and a bandwidth increase related to the data transmission is then performed, thereby determining a possibility that the first candidate part and second candidate part may be used as the first part and the second part.

For example, when the first media content is processed, if the latency degradation between the first candidate part and the second candidate part does not exceed a first threshold, e.g., 10%, and the bandwidth increase does not exceed a corresponding second threshold, e.g., 1.1 times, the first candidate part and the second candidate part may be used as the first part and the second part.

When the latency degradation of the first media content between the first candidate part and the second candidate part exceeds the first threshold or the bandwidth increase exceeds the corresponding second threshold, the first candidate part and the second candidate part are not used as the first part and the second part.

In some embodiments, the first media content and the second media content may be different media content that may contain different specific content information. Additionally, the first media content and the second media content may be different portions of the same original media content, the first media content and the second media content jointly constituting the complete original media content.

By this method, it is possible to, by putting the content provided by the user at the client for processing to avoid processing by the server, use the computing resources of the client and the server to a maximum degree, reduce the computational load of the server, and reduce the overall bandwidth of the service, and it is also possible to, by accelerating the computational task with the hardware at the client side, greatly improve the execution efficiency of the computational task, reasonably allocate the consumption of the computing resources, and improve the user's experience in performing the computational task.

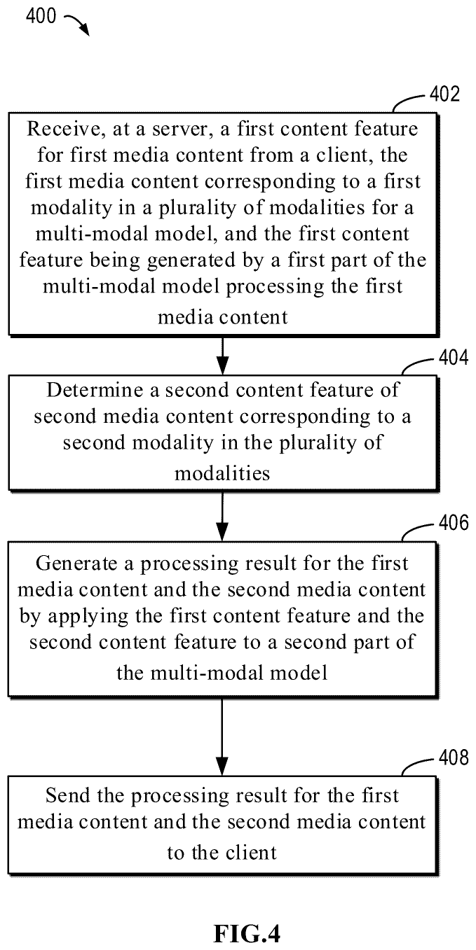

The schematic diagram of the example method 300 for processing data according to some embodiments of the present disclosure has been described above with reference to FIG. 3. Reference is then made below to FIG. 4 to describe a schematic diagram of an example method 400 for processing data according to some embodiments of the present disclosure. The method shown in FIG. 4 may be performed by the server 112 of FIG. 1 or any suitable device.

As shown in FIG. 4, in the example method 400, at block 402, a first content feature 108 for first media content 102 is received at a server 112 from a client 104, the first media content 102 corresponding to a first modality in a plurality of modalities of a multi-modal model, and the first content feature being generated by processing the first media content by a first part of the multi-modal model.

In some embodiments, after the first media content 102 is processed by the first part 106 of the multi-modal model deployed at the client 104, the server 112 receives from the client 104 the first content feature 108 for the first media content 102.

Additionally, the first content feature is a quantized first content feature. After the quantized first content feature is received, to ensure data accuracy when the second part further processes the first content feature, a dequantization process is first performed on the quantized first feature content. After the dequantization process is finished, the first content feature is then provided to the second part of the server-side multi-modal model for processing.

At block 404, a second content feature of second media content corresponding to a second modality in the plurality of modalities is determined. The multi-modal model may process data in multiple modalities. Additionally, in addition to processing the first media content 102 and the second media content 110, the multi-modal model may also process content features of other contents.

In some embodiments, similar to the first content feature 108, the second content feature 114 may also be obtained by the processing the second media content 110 by the client 104. In some embodiments, the second content feature 114 may be obtained by computing by applying the second media content to the second part of the multi-modal model deployed at the server.

At block 406, a processing result for the first media content and the second media content is generated by applying the first content feature and the second content feature to the second part of the multi-modal model, a computational load of the second part being greater than that of the first part, and a number of parameters of the second part being greater than that of the first part. The second part comprises a large-scale model computation part of the multi-modal model, and it may process the first content feature, the second content feature, and a combination thereof simultaneously. Additionally, when the multi-modal model may also process other contents, other content features may also be processed in the second part.

In some embodiments, when the second media content comprises image content, the multi-modal model is a stable diffusion model, and the second part is a contrastive language-image pre-training model and a U-shaped network model of the stable diffusion model.

In some embodiments, when the second media content comprises a video content, the multi-modal model is a bootstrapped language-image pre-training model using a frozen image encoder and a large language model, and the second part comprises another part of a vision transformer, a querying transformer, and a large language model.

At block 408, the processing result for the first media content and the second media content is sent to the client 104. After having finished processing the data feature, the server 112 returns the processing result to the client 104. For example, if the multi-modal model is a text-to-image generation model, the processing result is a generated image. Then, the client 104 presents the processing result.

By this method, it is possible to, by putting the content related to the user information at the client for processing, use the computing resources of the client and the server to a maximum degree, reduce the computational load of the server, and reduce the overall bandwidth of the service, and it is also possible to, by accelerating the computational task with the hardware at the client side, greatly improve the execution efficiency of the computational task, reasonably allocate the consumption of the computing resources, and improve the user's experience in performing the computational task.

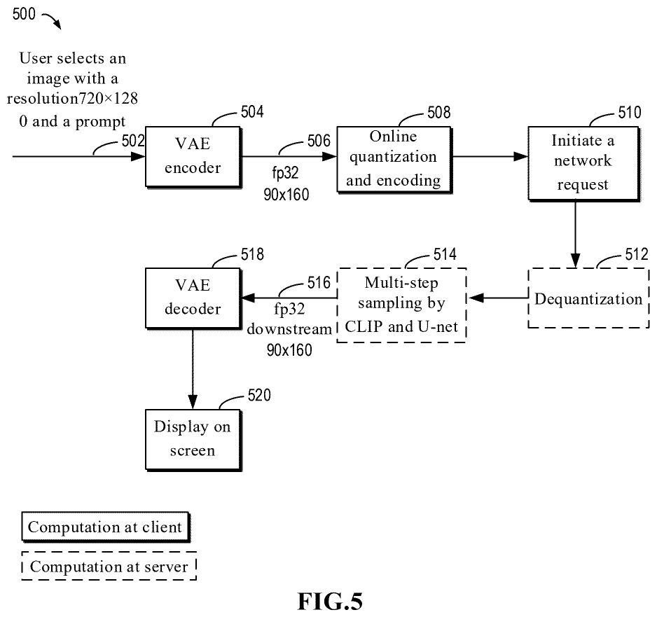

The schematic diagram of the example method 400 for processing data according to some embodiments of the present disclosure has already been described above with reference to FIG. 4. Reference is then made below to FIG. 5 to describe a schematic diagram of an example in which a multi-modal model is a stable diffusion model according to some embodiments of the present disclosure.

An example 500 shown in FIG. 5 is taken as an example in which the multi-modal model is a stable diffusion model, a first part is a variational autoencoder of the stable diffusion model, and a second part is a contrastive language-image pre-training model and a U-shaped network model of the stable diffusion model. The portions in the solid-border boxes represent computational tasks performed at the client, and the portions in the dashed-border boxes represent computational tasks performed at the server.

First, at the client, at 502, the user may select an image (resolution 720×1280) and a prompt, wherein the resolution of the image is not limited to 720×1280, the user may also select an image with other resolutions, for example, select an image with a resolution of 540×960, and the format of the image may be one of common image formats such as JPEG, JPG, PNG, etc., which is not limited to the present disclosure.

After the user selects the image, the image is input into a Variational Auto-Encoder (VAE) 504, and then the input image is processed using the VAE encoder, for example, the input image is calculated using the VAE encoder to obtain one eighth of the resolution of the original image, i.e., change the original image with the resolution of 720×1280 into eight images with a resolution of 90×160. When the image is processed, a data type for the image is also determined, e.g., the data type for the image is determined to be a 32-bit floating point, i.e., fp32 type.

Then, at 506, a compressed-encoded image feature is provided. Then, at 508, online quantization and encoding is performed to quantize the previously encoded image feature, then an operation such as PNG encoding is performed, and finally the quantized, encoded image feature is determined.

Then, at 510, the client 104 initiates a network request. After receiving the network request, the server 112 parses the network request. After the quantized image feature is obtained, a dequantization process is first performed at 512 at the server 112 to ensure that the dimensionality of the image features are the same as those before the quantization.

Then, at 514, the second part at the server performs an operation such as multi-step sampling on the image feature of the image selected by the user and the prompt text using the Contrastive Language-Image Pretraining (CLIP) model and the U-shaped Network (U-net) model; after the computational task of the second part is finished, at 516, the processing result obtained by processing, the data precision fp32, is further sent downstream to the client.

After receiving the processing result after the compressed-encoding, the client 104 performs a decoding operation using a VAE decoder 518, and finally the decoded processing result is displayed on a screen 520 at the client.

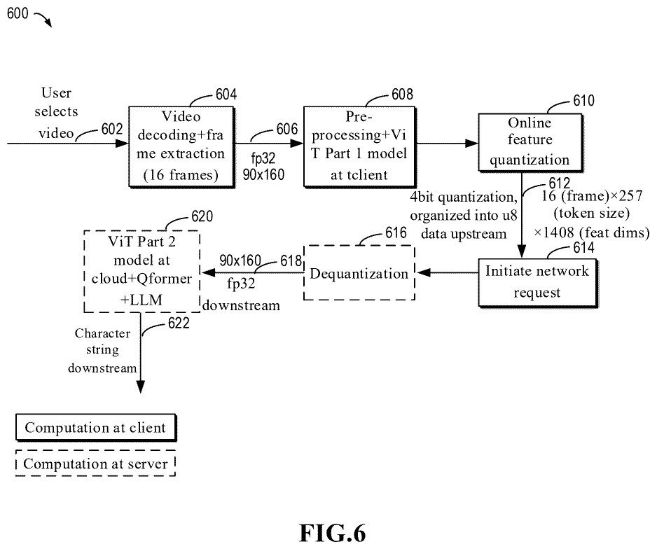

The schematic diagram of the example in which the multi-modal model is a stable diffusion model according to some embodiments of the present disclosure has been described above with reference to FIG. 5. Reference is then made below to FIG. 6 to describe a schematic diagram of an example where the multi-modal model is a bootstrapped-image pre-training model according to some embodiments of the present disclosure.

An example 600 shown in FIG. 6 is taken as an example in which the multi-modal model is a bootstrapped language-image pre-training model using a frozen image encoder and a large language model, a first part comprises one part of a Vision Transformer (ViT), and a second part comprises another part of the Vision Transformer, a Querying Transformer (Qformer), and a Large Language Model (LLM). The portions in the solid-border boxes represent computational tasks performed at the client, and the portions in dashed-border boxes represent computational tasks performed at the server.

First, at 602, the user selects a video, then after receiving the user-selected video, the client performs a video decoding+frame extraction (16 frames extracted) operation at 604. At this time, a decoding operation is performed on the user-selected compressed video, and a group of video frames including 16 frames are extracted from the video using a frame extraction algorithm or a frame extraction script. Then, like example 500, the resolution of each video frame in the group of video frames is also adjusted to 90×160, and the type of data for the image is determined to be a 32-bit floating point.

Then, at 608, pre-processing and processing by a ViT part 1 model at the client are performed, the part 1 being one part of the vision transformer. At this time, a group of video frames may be pre-processed first, including adjusting the size of the images corresponding to the video frames, performing spatial conversion for image colors or performing a normalization process, etc. and then processing with the part of the ViT.

Then, at 610, online feature quantization is performed. At 612, the feature is quantized in a 4-bit manner and organized as an 8-bit integer (u) 8 data sent upstream to the network server, wherein the u8 data is calculated in the following manner: 16 (frame)×257(tokensize)×1408 (feat dims).

Then, at 614, the client initiates a network request, and after receiving the network request, the server also dequantizes the quantized group of video frames at 616, and provides a group of video frame images with a resolution of 90×160 to part 2 of the model, i.e., sends the content feature as 32-bit floating-point data downstream to the part 2 of the multi-modal model, i.e., the cloud ViT part 2 model, Qformer and LLM 620. Then, at 622, a processing result after the processing is sent upstream to the client in the form of a character string.

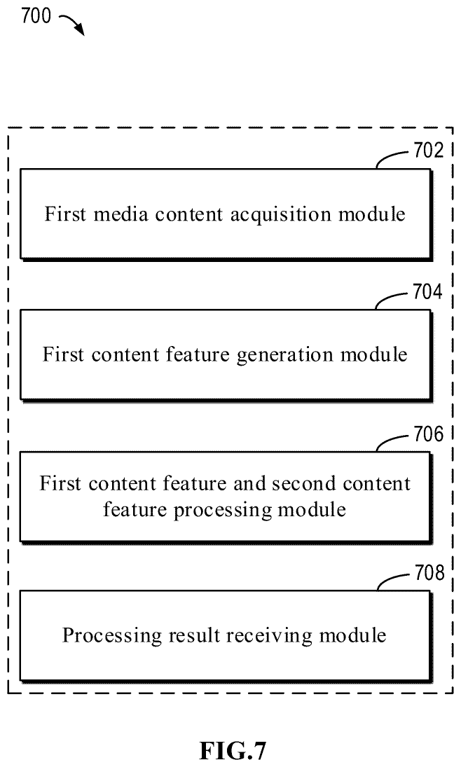

As shown in FIG. 7, an apparatus 700 comprises a first media content acquisition module 702 configured to acquire first media content at a client, the first media content corresponding to a first modality in a plurality of modalities for a multi-modal model; a first content feature generation module 704 configured to generate a first content feature for the first media content based on a first part of the multi-modal model deployed at the client; a first content feature and second content feature processing module 706 configured to send the first content feature to the server to process the first content feature and a second content feature of second media content corresponding to a second modality in the plurality of modalities using a second part of the multi-modal model deployed on the server, a computational load of the second part being greater than that of the first part, and a number of parameters of the second part being greater than that of the first part; and a processing result receiving module 708 configured to receive from the server a processing result for the first media content and the second media content output by the multi-modal model.

In some embodiments, the first content feature and second content feature processing module 706 comprises: a first content feature quantization module configured to quantize the first content feature to generate a quantized first content feature; and a quantized first content feature sending module configured to send the quantized first content feature to the server.

In some embodiments, the quantized first content feature sending module comprises: a first content feature encoding module configured to encode the quantized first content feature to generate an encoded first content feature; and an encoded first content feature sending module configured to send the encoded first content feature to the server.

In some embodiments, the first media content comprises an image, and the first content feature generation module 704 comprises: an image dimensionality reduction module configured to reduce the dimensionality of the image using the first part of the multi-modal model to generate the first content feature for the image.

In some embodiments, the multi-modal model is a stable diffusion model, the first part is a variational autoencoder of the stable diffusion model, and the second part is a contrastive language-image pre-training model and a U-shaped network model of the stable diffusion model.

In some embodiments, the apparatus 700 further comprises: a processing result decoding module configured to perform a decoding operation on the processing result.

In some embodiments, the first media content comprises a video, and the first content feature generation module 704 comprises: a video decoding module configured to perform a decoding operation on the video to determine a decoded video; a group of video frames determination module configured to determine a group of video frames for the video by extracting frames from the decoded video; a group of video frames pre-processing module configured to pre-process the group of video frames to generate a group of pre-processed video frames; and a first content feature generation module configured to generate a first content feature for the group of preprocessed video frames based on the first part of the multi-modal model deployed at the client.

In some embodiments, the pre-processing of the group of video frames comprises at least one of: a video frame size adjustment module configured to adjust the size of each video frame in the group of video frames; an image color space conversion module configured to perform space conversion on an image color of the video frame; or a video frame normalization module configured to perform a normalization process on the video frame.

In some embodiments, the multi-modal model is a bootstrapped language-image pre-training model using a frozen image encoder and a large language model, the first part comprises one part of a vision transformer, and the second part comprises another part of the vision transformer, a querying transformer and a large language model.

In some embodiments, the apparatus 700 further comprises: a multi-modal model dividing module configured to divide the multi-modal model into a first candidate part deployable at the client and a second candidate part deployable at the server; a latency degradation and bandwidth increase determination module configured to determine, based on the first media content, a latency degradation of data transmission between the first candidate part and second candidate part and a bandwidth increase between the client and the server; and a possibility determination module configured to determine a possibility that the first candidate part and the second candidate part are used as the first part and the second part based on the latency degradation and the bandwidth increase.

In some embodiments, the first media content and the second media content comprise at least one of: video content, image content, text content and audio content.

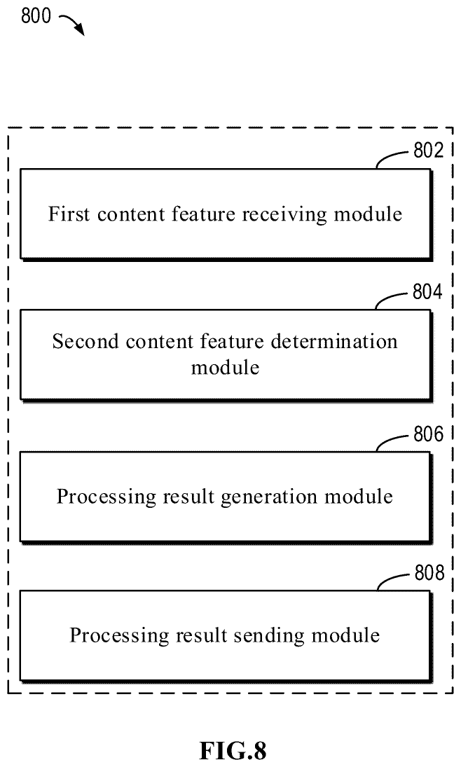

As shown in FIG. 8, an apparatus 800 comprises a first content feature receiving module 802 configured to receive, at a server, a first content feature for first media content from a client, the first media content corresponding to a first modality in a plurality of modalities for a multi-modal model, and the first content feature being generated by a first part of the multi-modal model processing the first media content; a second content feature determination module 804 configured to determine a second content feature of second media content corresponding to a second modality in the plurality of modalities; a processing result generation module 806 configured to generate a processing result for the first media content and the second media content by applying the first content feature and the second content feature to a second part of the multi-modal model, a computational load of the second part being greater than that of the first part, and a number of parameters of the second part being greater than that of the first part; and a processing result sending module 808 configured to send the processing result for the first media content and the second media content to the client.

In some embodiments, the first content feature receiving module 802 comprises: a quantized first content feature receiving module configured to receive at a server a quantized first content feature for first media content from the client.

In some embodiments, the processing result generation module 806 comprises: a quantized first content feature dequantization module configured to obtain the first content feature by dequantizing the quantized first content feature; and a processing result generation module configured to generate processing results for the first media content and the second media content by applying the first content feature and the second content feature to the second part of the multi-modal model.

In some embodiments, the multi-modal model is a stable diffusion model, the first part is a variational autoencoder of the stable diffusion model, and the second part is a contrastive language-image pre-training model and a U-shaped network model of the stable diffusion model.

In some embodiments, the multi-modal model is a bootstrapped language-image pre-training model using a frozen image encoder and a large language model, the first part comprises one part of a vision transformer, and the second part comprises another part of the vision transformer, a querying transformer and a large language model.

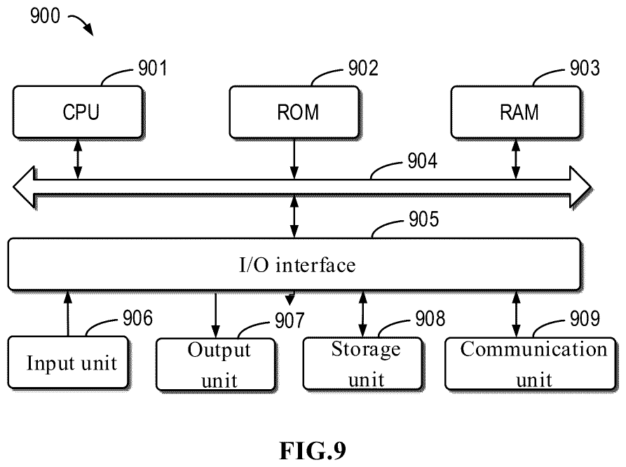

FIG. 9 illustrates a schematic block diagram of an example device 900 for implementing embodiments of the present disclosure. The client 104 and server 112 in FIG. 1 may be implemented using the device 900. As shown in FIG. 9, the device 900 comprises a Central Processing Unit (CPU) 901 which may perform various suitable acts and processes in accordance with a computer program instruction stored in a Read Only Memory (ROM) 902 or a computer program instruction loaded from a storage unit 908 into a Random Access Memory (RAM) 903. In the RAM 903, various programs and data needed by the operation of the device 900 are also stored. The CPU 901, the ROM 902, and the RAM 903 are connected to one another via a bus 904. An input/output (I/O) interface 905 is also coupled to the bus 904.

A plurality of components in the device 900 are connected to the I/O interface 905, and include: an input unit 906, such as a keyboard, a mouse, etc. ; an output unit 907 such as various types of displays, speakers, and the like; a storage unit 908, such as a magnetic disk, an optical disk, etc. ; and a communication unit 909 such as a network card, a modem, a wireless communication transceiver, etc. The communication unit 909 allows the device 900 to exchange information/data with other devices over a computer network such as the Internet and/or various telecommunication networks.

The various methods or processes such as methods 300 and 400 described above may be performed by the processing unit 901. For example, in some embodiments, the methods 300 and 400 may be implemented as a computer software program tangibly embodied on a machine-readable medium, such as storage unit 908. In some embodiments, part or all of the computer program may be loaded and/or installed on the device 900 via ROM 902 and/or communication unit 909. One or more acts in the example methods 300 and 400 described above may be performed when the computer program is loaded into the RAM 903 and executed by the CPU 901.

The present disclosure may relate to methods, apparatuses, systems and/or computer program products. The computer program product may include a computer readable storage medium having computer readable program instructions embodied thereon for performing various aspects of the present disclosure.

The computer-readable storage medium may be a tangible device that can hold and store instructions for use by an instruction execution device. The computer readable storage medium may be, for example but not limited to, an electrical storage device, a magnetic storage device, an optical storage device, an electromagnetic storage device, a semiconductor storage device, or any suitable combination of the above. A non-exhaustive list of more specific examples of the computer readable storage medium comprises the following: a portable computer diskette, a hard disk, a Random Access Memory (RAM), a Read-Only Memory (ROM), an Erasable Programmable Read-Only Memory (EPROM or flash memory), a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++, etc., and conventional procedural programming languages such as “C” language or a similar programming language. The computer readable program instructions may execute entirely on the user's computer, partly on the user's computer, as a stand-alone software package, partly on the user's computer and partly on a remote computer or entirely on the remote computer or server. In the case of the remote computer, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, Field-Programmable Gate Arrays (FPGA), or Programmable Logic Arrays (PLA) may execute the computer readable program instructions by utilizing state information of the computer readable program instructions to personalize the electronic circuitry, in order to implement aspects of the present disclosure.

Aspects of the present invention are described herein with reference to flowchart illustrations and/or block diagrams of methods, apparatus (systems), and computer program products according to embodiments of the invention. It should be appreciated that each block of the flowchart illustrations and/or block diagrams, and combinations of blocks in the flowchart illustrations and/or block diagrams, may be implemented by computer readable program instructions.

These computer readable program instructions may be provided to a processing unit of a general-purpose computer, special-purpose computer, or other programmable data processing apparatus to produce a machine, such that the instructions, which executed via the processing unit of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable data processing apparatus or other device to produce a computer implemented process, such that the instructions executed on the computer, other programmable data processing apparatus, or other device implement the functions/acts specified in one or more blocks in the flowcharts and/or block diagrams.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special-purpose hardware and computer instructions.

The depictions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

I/We claim:

1. A method for processing data, comprising:
acquiring first media content at a client, the first media content corresponding to a first modality in a plurality of modalities for a multi-modal model;
generating a first content feature for the first media content based on a first part of the multi-modal model deployed at the client;
sending the first content feature to a server to process the first content feature and a second content feature of second media content corresponding to a second modality in the plurality of modalities by using a second part of the multi-modal model deployed on the server, a computational load of the second part being greater than that of the first part, and a number of parameters of the second part being greater than that of the first part;
receiving from the server a processing result for the first media content and the second media content output by the multi-modal model.

2. The method according to claim 1, wherein the sending the first content feature to the server to process the first content feature and the second content feature of the second media content corresponding to the second modality in the plurality of modalities by using the second part of the multi-modal model deployed on the server comprises:
quantizing the first content feature to generate a quantized first content feature; and
sending the quantized first content feature to the server.

3. The method according to claim 2, wherein the sending the quantized first content feature to the server comprises:
encoding the quantized first content feature to generate a encoded first content feature; and
sending the encoded first content feature to the server.

4. The method according to claim 1, wherein the first media content comprises an image, and the generating the first content feature for the first media content comprises:
reducing the dimensionality of the image by using the first part of the multi-modal model to generate the first content feature for the image.

5. The method according to claim 4, wherein the multi-modal model is a stable diffusion model, the first part is a variational autoencoder of the stable diffusion model, and the second part is a contrastive language-image pre-training model and a U-shaped network model of the stable diffusion model.

6. The method according to claim 5, further comprising:
performing a decoding operation on the processing result.

7. The method according to claim 1, wherein the first media content comprises a video, and the generating the first content feature for the first media content comprises:
performing a decoding operation on the video to determine a decoded video;
determining a set of video frames for the video by extracting frames from the decoded video;
pre-processing the set of video frames to generate the set of pre-processed video frames; and
generating a first content feature for the set of pre-processed video frames based on the first part of the multi-modal model deployed at the client.

8. The method according to claim 7, wherein the pre-processing the set of video frames comprises at least one of:
adjusting a size of each video frame in the set of video frames;
performing space conversion on an image color of the video frame; or
performing a normalization process on the video frame.

9. The method according to claim 8, wherein the multi-modal model is a bootstrapped language-image pre-training model using a frozen image encoder and a large language model, the first part comprises one part of a vision transformer, and the second part comprises another part of the vision transformer, a querying transformer and a large language model.

10. The method according to claim 1, further comprising:
dividing the multi-modal model into a first candidate part deployable at the client and a second candidate part deployable on the server;
determining, based on the first media content, a latency degradation of data transmission between the first candidate part and the second candidate part and a bandwidth increase between the client and the server; and
determining a possibility that the first candidate part and the second candidate part are used as the first part and the second part, which is based on the latency degradation and the bandwidth increase.

11. The method according to claim 1, wherein the first media content and the second media content comprise at least one of:
video content, image content, text content and audio content.

12. A method for processing data, comprising:
receiving, at a server, a first content feature for first media content from a client, the first media content corresponding to a first modality in a plurality of modalities for a multi-modal model, and the first content feature being generated by a first part of the multi-modal model processing the first media content; determining a second content feature of second media content corresponding to a second modality in the plurality of modalities;
generating a processing result for the first media content and the second media content by applying the first content feature and the second content feature to a second part of the multi-modal model, a computational load of the second part being greater than that of the first part, and a number of parameters of the second part being greater than that of the first part; and
sending the processing result for the first media content and the second media content to the client.

13. The method according to claim 12, wherein the receiving, at a server, a first content feature for first media content from a client comprises:
receiving at the server a quantized first content feature for first media content from the client,
wherein the generating the processing result for the first media content and the second media content by applying the first content feature and the second content feature to the second part of the multi-modal model comprises:
obtaining the first content feature by dequantizing the quantized first content feature; and
generating processing results for the first media content and the second media content by applying the first content feature and the second content feature to the second part of the multi-modal model,
wherein the multi-modal model is a stable diffusion model, the first part is a variational autoencoder of the stable diffusion model, and the second part is a contrastive language-image pre-training model and a U-shaped network model of the stable diffusion model, and
wherein the multi-modal model is a bootstrapped language-image pre-training model using a frozen image encoder and a large language model, the first part comprises one part of a vision transformer, and the second part comprises another part of the vision transformer, a querying transformer and a large language model.

14. The method according to claim 12, further comprising:
dividing the multi-modal model into a first candidate part deployable at the client and a second candidate part deployable on the server;
determining, based on the first media content, a latency degradation of data transmission between the first candidate part and the second candidate part and a bandwidth increase between the client and the server; and
determining a possibility that the first candidate part and the second candidate part are used as the first part and the second part, which is based on the latency degradation and the bandwidth increase.

15. An electronic device, comprising:
one or more processors;
a storage device for storing one or more programs, wherein,
the one or more programs, when executed by the one or more processors, cause the one or more processors to:
acquire first media content at a client, the first media content corresponding to a first modality in a plurality of modalities for a multi-modal model;
generate a first content feature for the first media content based on a first part of the multi-modal model deployed at the client;
send the first content feature to a server to process the first content feature and a second content feature of second media content corresponding to a second modality in the plurality of modalities by using a second part of the multi-modal model deployed on the server, a computational load of the second part being greater than that of the first part, and a number of parameters of the second part being greater than that of the first part;
receive from the server a processing result for the first media content and the second media content output by the multi-modal model.

16. The device according to claim 15, wherein the one or more programs causing the one or more processors to send the first content feature to the server to process the first content feature and the second content feature of the second media content corresponding to the second modality in the plurality of modalities by using the second part of the multi-modal model deployed on the server comprise instructions to:
quantize the first content feature to generate a quantized first content feature; and
send the quantized first content feature to the server.

17. The device according to claim 16, wherein the one or more programs causing the one or more processors to send the quantized first content feature to the server comprise instructions to:
encode the quantized first content feature to generate a encoded first content feature; and
send the encoded first content feature to the server.

18. The device according to claim 15, wherein the first media content comprises an image, and the one or more programs causing the one or more processors to generate the first content feature for the first media content comprise instructions to:
reduce the dimensionality of the image by using the first part of the multi-modal model to generate the first content feature for the image.

19. The device according to claim 18, wherein the multi-modal model is a stable diffusion model, the first part is a variational autoencoder of the stable diffusion model, and the second part is a contrastive language-image pre-training model and a U-shaped network model of the stable diffusion model.

20. The device according to claim 19, the one or more programs further causing the one or more processors to:
perform a decoding operation on the processing result.
